(19) United States
(12) Patent Application Publication
(10) Pub. No.: US 2012/0143711 A1
(43) Pub. Date: Jun. 7, 2012

(54) Electronic Sales With Decreasing Price

(76) Inventors: Jeremy Andrew Kugel, Silver Spring, MD (US); Andrew John O'Mara, Silver Spring, MD (US)

(21) Appl. No.: 13/312,248

(22) Filed: Dec. 6, 2011

Related U.S. Application Data
(60) Provisional application No. 61/420,637, filed on Dec. 7, 2010.

(51) Int. Cl. G06Q 30/06

(52) U.S. Cl. 705/26.2

(57) ABSTRACT

A pricing method, having multiple buyers collaborating virtually to achieve a declining price schedule for a given product or service. The method invites buyers to commit at a certain price, which may or may not be the price they ultimately pay. The price may or may not decline as more buyers commit. All buyers pay the same (lowest) price, at the end of the finite sale period.

### CROSS REFERENCE TO RELATED APPLICATIONS

This application claims the benefit of U.S. Provisional Patent Application Ser. No. 61/420,637, entitled “Electronic Sales with Decreasing Price”, filed Dec. 7, 2010, which is incorporated herein by reference.

### TECHNICAL FIELD

This document relates to computer-based systems and techniques for establishing and executing a dynamic pricing structure.

### BACKGROUND

eCommerce continues to expand, as more users of the internet learn the benefits of buying items on-line. On-line sales can take the form of ordinary sales sites like AMAZON or auction sites like EBAY. These sites allow people to buy goods that they might not have access to in their home areas, and to do so from their home or office, and at all hours of the day. In addition, auction sites allow people to find goods and services to which they might not otherwise have access.

Some internet services provide for limited-time sales. For example, WOOT! lists a single new item each night at midnight, and makes the item available for sale until the stock runs out (though at times, it posts a new item before the next midnight time). GROUPON provides subscribers with local coupons that can be purchased immediately and used at a corresponding vendor, such as by providing 50% off at a local spa.

### SUMMARY

This document describes systems and techniques that may be used to enact a pricing mechanism where the retail price is volatile, decreasing (such as in a step function) as more customers commit to buying a particular product or service. The price for a given product or service is initially posted at “6X”, and as more customers “buy in”, the price decreases to “6Y”, then (potentially) “6Z”, where X>Y>Z. Customers who buy in are not charged immediately; rather all purchases are executed at the end of the finite sale period and all customers are charged the same (lowest) price. Customers may “buy in” at the initial price, thereby committed to purchase at that price or a lower price, but their credit cards are not charged. They are invited to “spread the word” and told that “the more people who buy, the lower the price for all”. As more people commit to the offer, the initial or retail price may (or may not) decrease in whole-dollar steps. The price will never go above the initial price to which the buyers committed. At the end of the finite sale period (which is usually 24-72 hours, but can be set to expire as soon as the price reaches a predetermined minimum or the volume reaches a predetermined maximum, which may be the minimum a vendor is willing to accept or a maximum the vendor is will to deliver), all customers are charged the same low price, which may or may not be lower than the price at which they “bought in”.

In one implementation, a computer-implemented method for making goods or services available to buyers is disclosed. The method comprises making available for purchase, by a computer server system at an on-line service and to a plurality of potential buyers, one or more goods or services in an on-line electronic marketplace, including by pricing the goods or services at an initial price; receiving requests to purchase the one or more goods or services from a plurality of actual buyers from among the plurality of potential buyers; determining at the end of a predetermined time period an actual price for the goods or service based on a number of actual buyers who request to purchase the one or more goods, and automatically billing the plurality of actual buyers for the one or more goods or services at the determined actual price and causing the one or more goods or services to be made available to the plurality of actual buyers. The method can also comprise announcing an initial price for the one or more goods or services to the plurality of potential buyers before receiving requests to purchase from the plurality of potential buyers, the initial price serving as a maximum price any buyer will pay for the one or more goods or services. Also, the method can comprise periodically updating a real-time price for the one or more goods or services to be shown to the plurality of potential buyers after initially making the one or more goods or services available for purchase, the real-time price falling from the initial price as a function of the number of actual buyers.

In some aspects, the real-time price falls in pricing steps that correspond to the number of actual buyers in groups of a predetermined size. Also the group sizes and corresponding price changes can be determined before making the one or more goods or services available for purchase. The method can also include periodically updating a real-time discount for the one or more goods or services to be shown to the plurality of potential buyers after initially making the one or more goods or services available for purchase, the real-time discount increasing from an initial discount as a function of the number of actual buyers. Moreover, the method can include providing the plurality of potential buyers with an agreement that indicates that actual buyers are bound to purchase the one or more goods or services at a price that will not exceed the initial price. In addition, the method can include providing to potential or actual buyers a user-selectable control whose selection enables the potential or actual buyers to notify social contacts about the one or more goods or services so as to spread notice of the one or more goods or services being for sale.

In other implementations, the method comprises receiving from a particular first user a referral that identifies a particular second user, and providing the particular first user with a credit in response to receiving the referral. The credit can not be provided until the particular second user has been determined to have made a purchase with the on-line service. In addition, the method can comprise maintaining a roster of registered users, the registered users having provided identification information so that different visits by a particular registered user can be correlated with each other, and requiring registration by a particular user before the particular user can become an actual buyer. Moreover, the method can include providing code to computing devices of the potential buyers showing a time remaining until a sale will close so as to trigger the determination of the actual price. The method can also include providing to the plurality of potential buyers an indication of a minimum price or maximum discount that can be achieved for the one or more goods or services.

In other aspects, the minimum price or maximum discount has been previously negotiated with a provider of the one or more goods or services. The method also includes placing a credit card hold on a particular buyer when the particular buyer submits a request to purchase, and executing a charge to the particular buyer's credit card for the actual price after the actual price has been determined. The credit card hold can be for an amount that corresponds to the initial price.

In another implementation, a computer-implemented system for making goods or service available to buyers is disclosed, and comprises a web interface arranged to serve code for display on computing devices for a plurality of potential buyers of one or more goods or services; a dynamic web page generator programmed to generated the code so as to display the one or more goods or services and pricing for the one or more goods or services; a sales module programmed to receive orders for the one or more goods or services from a plurality of actual buyers and to register the actual buyers as being buyers of the one or more goods or services upon expiration of a current sales period; and a price determiner arranged to set a price for the one or more goods or services as a function a number of actual buyers.

In certain implementations, such systems and technique may provide one or more advantages. For example, this mechanism creates an incentive for consumers to “spread the word”, encouraging more awareness and buyers, and therefore benefitting the process owner, Jasmere.com.

The details of one or more embodiments are set forth in the accompanying drawings and the description below. Other features and advantages will be apparent from the description and drawings, and from the claims.

### DESCRIPTION OF DRAWING

FIG. 1 is a conceptual diagram of this pricing mechanism in which a price charged to buyers is a function of the number of buyers.

FIG. 2 is a block diagram of a system for providing user-based pricing for goods or services.

FIG. 3 shows a schematic diagram of components in a pricing system.

FIGS. 4, 4A, 4B and 4C are a screen shots of a system for providing user-based pricing.

FIG. 5 is a flow chart of a process for user-based pricing of goods or services.

FIG. 6 is a block diagram of computing devices that may be used to implement the systems and methods described in this document, as either a client or as a server or plurality of servers.

### DETAILED DESCRIPTION

This document describes systems and techniques for a dynamic pricing model for the sales of goods and services. Such techniques may include posting a price for a given product or service; encouraging customers to “buy in” at that price, although their credit cards are not charged yet for that price; inviting customers to “spread the word” and informing them that “the more people who buy, the lower the price for all;” potentially changing the retail or initial price downwardly in whole-dollar steps; and charging all customers the same (lowest) price at the end of a predetermined and finite sale period. The present invention thereby provides consumers with a limited time offer in a daily deal environment.

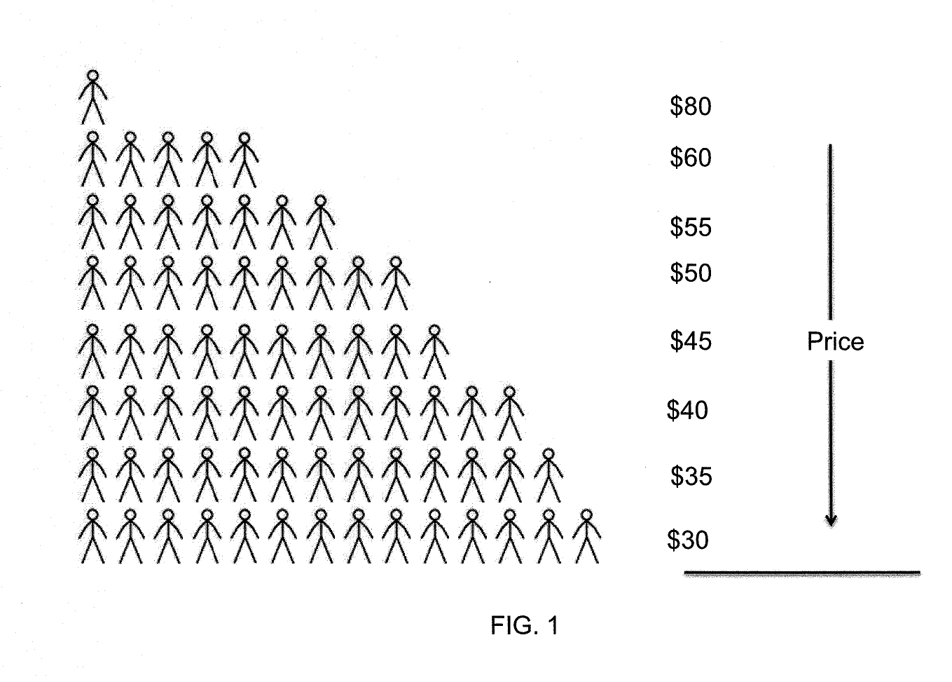

FIG. 1 is a conceptual diagram of the pricing mechanism facilitated by the present system. In general, the figure shows a number of purchasers on the left, and a price of an item on the right. The item may have been listed for sale on a web site such as www.jasmere.com, and that page may be viewed by any member of the public. In certain implementations, some or all information about a sale may be limited to users who have previously registered with the service (e.g., by providing contact information and a password, and perhaps by providing a credit card, PAY PAL, or similar account information by which the users can be charged automatically if they choose to make a purchase).

A top price on the right is an initial or retail price at which the item was initially listed (e.g., when the item first went on sale at a preset time, or upon the expiration of another item being made for sale). As shown by the two sides, the price decreases as more buyers commit to buying the item. The decreases may occur for each buyer, for each X buyers, for each unit change in price (e.g., for every dollar, 5 dollars, 10 dollars, etc.), or on another basis. In accordance with a preferred embodiment, the price is dropped at certain predetermined quantity points (or “steps”), that is, price drops are enacted when predetermined quantities of units have been purchased. There may be multiple predetermined “steps” for each product being sold and the predetermined “steps” may be varied for each product being sold. The price starts in the example shown in FIG. 1 at $60 although the “street” retail price for the item may be $80, so even if only one customer buys, they will still get a base discount. The price stops decreasing in this example at $30, which may be a minimum acceptable price for the supplier of the item (which may be the same company that runs the process or a third-party that contracts to fulfill the items), at some share of the final price (where the party that runs the process takes a commission of some form).

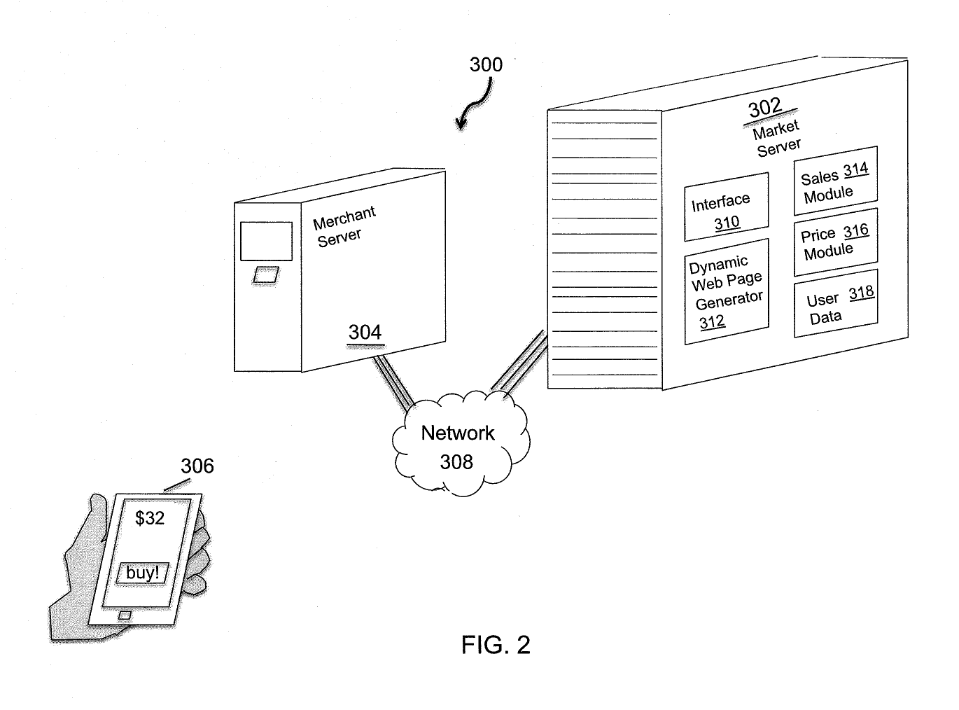

FIG. 2 is a block diagram of a system 300 for providing user-based pricing for goods or services in accordance with the present invention. In general, the system 300 includes a market server 302 that generates web page(s) showing one or more items that can be purchased by registered users of the system 300. The item may be posted at a certain time each day, and the sale may run to another predetermined time (e.g., midnight for each, with a new product each day). The product may be viewed by a computing device 306, which accesses data for a web page from the market server 302 through a network 308 for example, a global communication network, such as the internet. In some embodiments, a merchant server system 304 may be involved, and may be notified by the market server 302 when a sale is complete. For example, the market server 302 may provide addresses for purchasers of an item so that the merchant server 304 may ship items to the purchasers. Also, the operators of the market server 302 and the merchant server system 304 may have a preexisting legal arrangement by which the operator of the merchant server system 304 is paid a certain amount for each sale. The amount may relate to the amount paid by purchasers, and may be an inverse function of the volume of sales (capped at an upper and lower end, as discussed above).

The market server 302 includes an interface (for example, a web interface) 310, which may be a web server system, for generating code to be delivered to browsers or other applications at the client device 306 for showing items (that is, goods and services) to be sold and for interacting with a user of device 306 who wants to be a confirmed purchaser for an item. The market server also includes a dynamic web page generator 312 that generates code served by the interface 310 for display of the items, which may include a current real-time price for the item, where the price may fall as the number of items purchased increases, and the price may be computed by a price module (or determinator) 316 in manners like those discussed for FIG. 1. That is, the price module 316 sets a price for one or more goods or services as a function of a number of actual buyers. The market server 302 also includes a sales module 314 that keeps track of which registered users have committed to buy an item, and may also register new users, while a user data storage device 318 (for example, database) may keep track of personal user information such as email addresses and credit cards numbers, in a conventional manner .

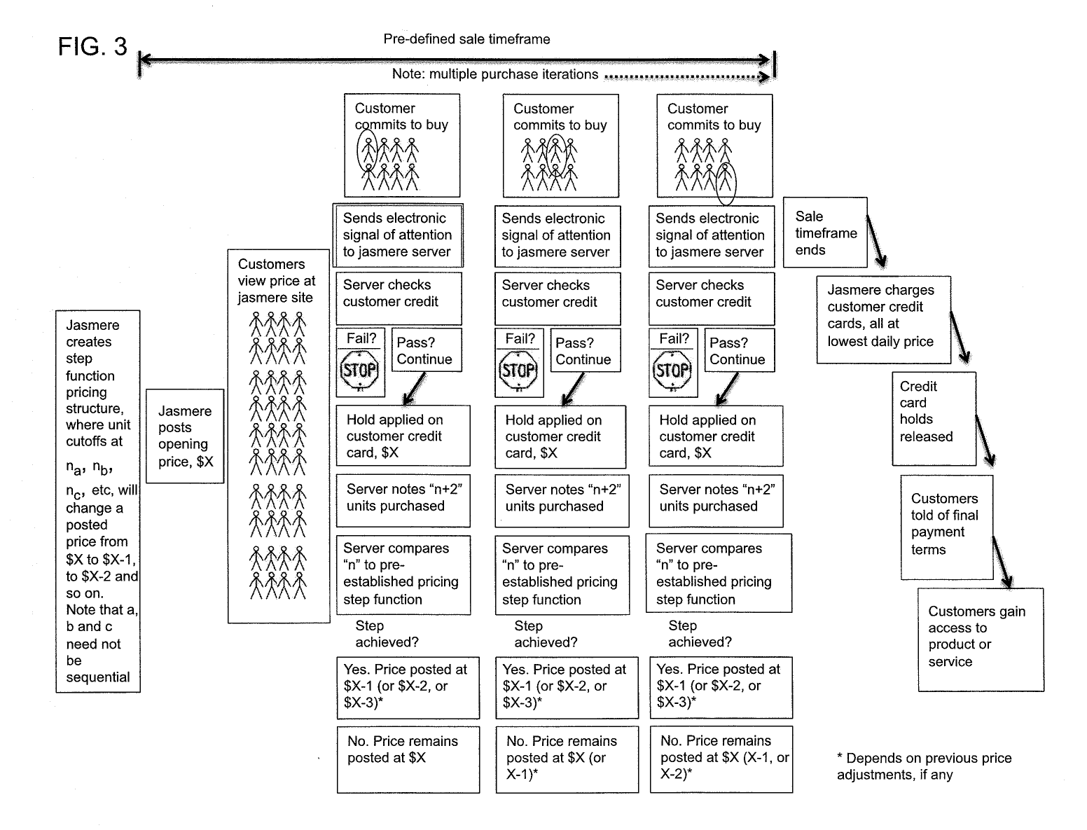

FIG. 3 shows a schematic diagram of components in a pricing system in accordance with the present invention. The figure generally shows interactions that may occur with users of present system as disclosed herein, with the timeline of interactions moving from the left in the figure to the right. The descriptions in the boxes in the figure are generally self-explanatory and consistent with the other points discussed above and below.

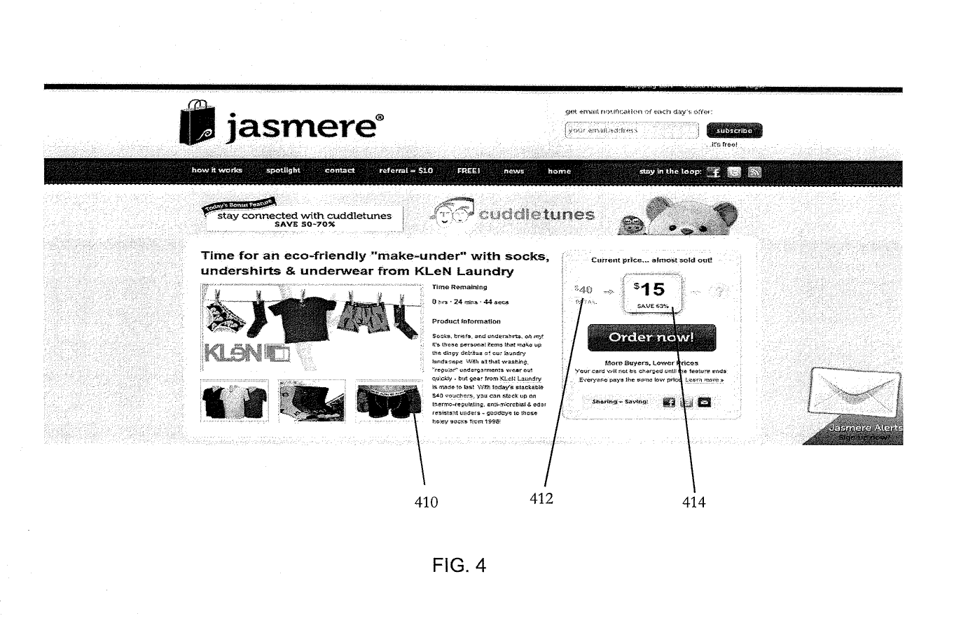

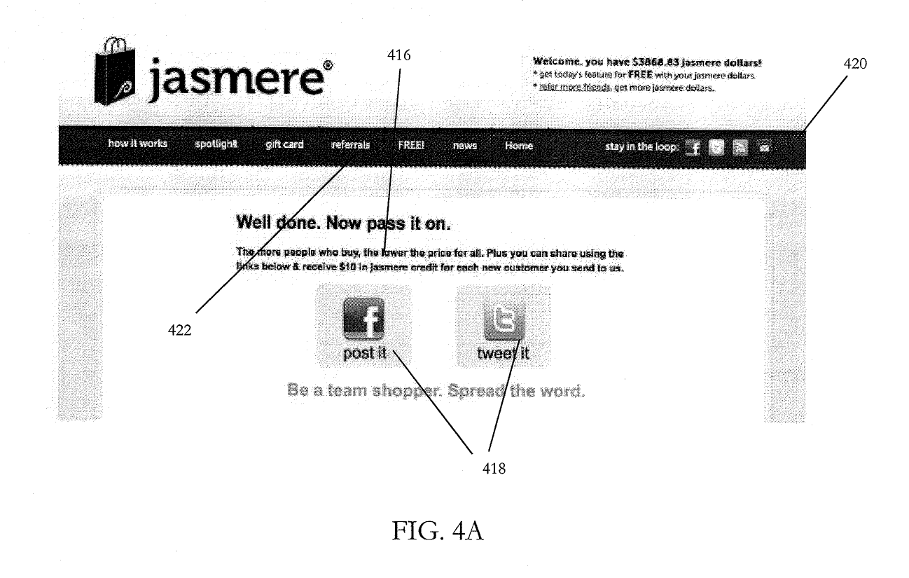

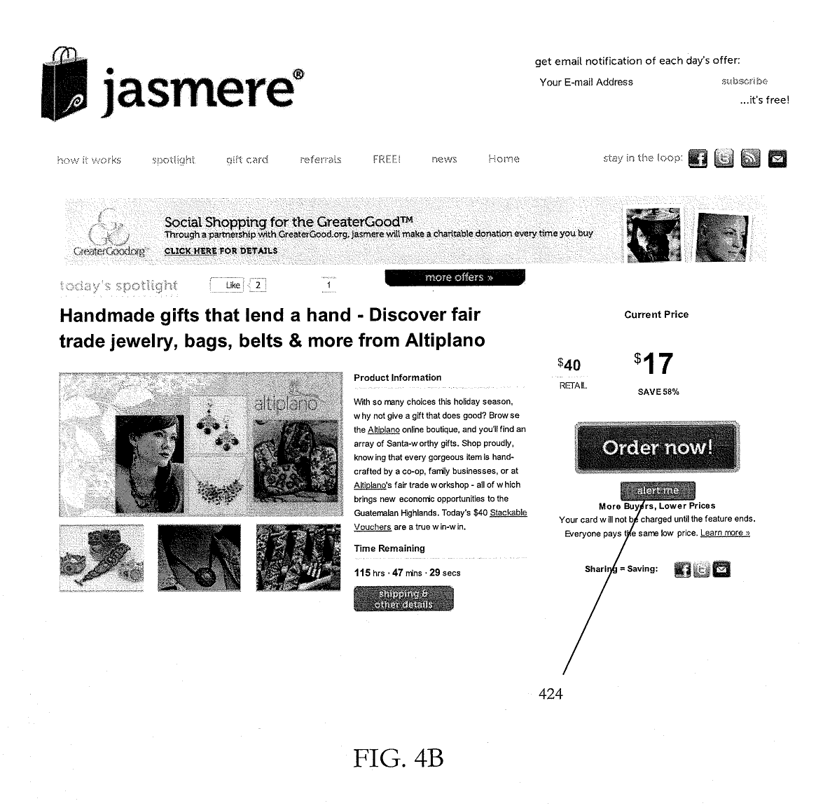

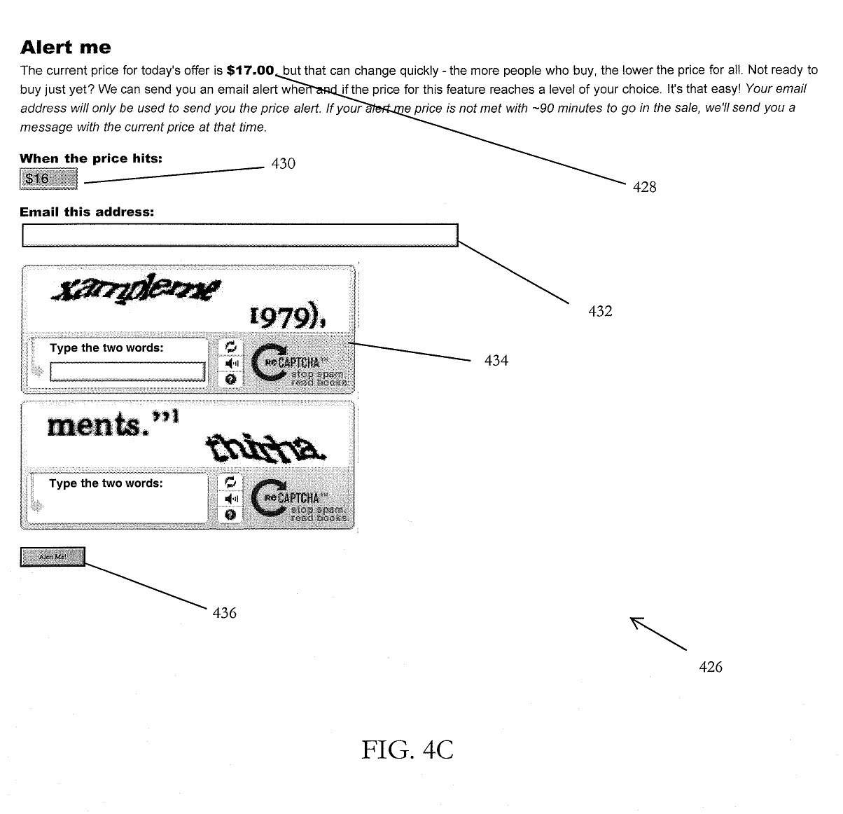

FIG. 4 is a screen shot of a web page of the present system for providing user-based pricing. This is a shot of the www.jasmere.com web page on a particular day, and it shows a description of items for sale 410, provides a retail or initial price of $40 (as indicated by reference numeral 412), and shows a current price of $15 (a 63% discount) from the retail price (as indicated by reference numeral 414). A user chooses a user-selectable control to complete an order in a familiar manner (where the user's credit card may have a hold placed on it for $15 in real time, but will not be charged until the sale is complete, and then at the final price for the sale, where the price might fall further from $15 is more people buy before the end of the sale). With reference to FIG. 4A, a short instruction 416 is displayed to indicate to the user that more buyers will cause the price to fall, and icons with links 418 to social networking sites (and email) are provided so that friends of the user can be notified of the sale in a familiar manner (e.g., on the user's wall) if the user selects one or more of the icons. In addition, at the top in a ribbon of selectable options 420, a user can select to refer a friend to the system 422, and if the friend follows up (e.g., by receiving an email from the system that includes a URL that identifies the transaction, and then clicking on the URL), the user can be rewarded, such as by getting a credit or other item of value when the friend registers or makes a first purchase or a certain dollar value of purchases. In accordance with yet another embodiment of the present invention, and with reference to FIGS. 4B and 4C, the system may provide consumers with the option of receiving pricing alerts should they not want to commit to purchase at a specific price. In particular, a consumer wishing to receiving pricing alerts simply clicks upon the “alert me” tab 424 (see FIG. 4B), which will cause the pop-up display 426 shown in FIG. 4C to be displayed. The pop-up display 426 instructs the consumer as to the current price for a product 428, but provides the consumer with the option to receive an email alert when the price reaches a level more desirable to the consumer. The consumer may then use a drop down menu 430 to specify a price at which he or she wishes to receive the alert and an input box 432 in which the consumer inputs his or her email address. Once this is completed, the user completes the cryptographs 434 and clicks upon the “Alter Me” tab 436. The user will then receive an alert when the price reaches the predetermined level.

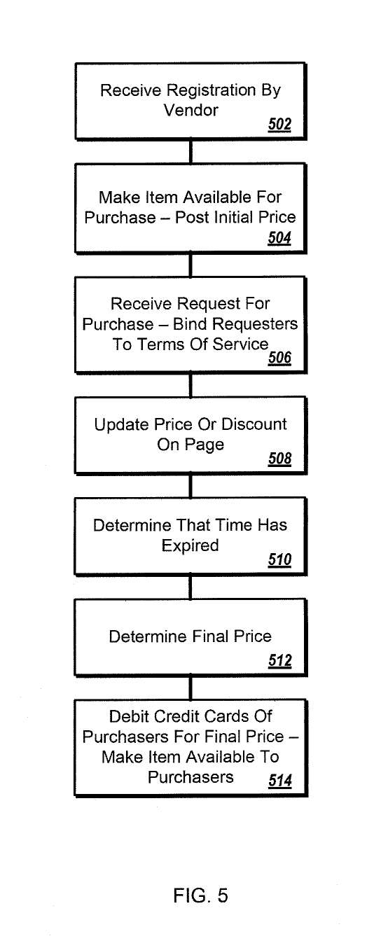

FIG. 5 is a flow chart of a process for user-based pricing of goods or services. At box 502, the process receives registration by vendor; that is, the vendor signs-up (registers) via a contract to promote their products or services on the site operating in accordance with the present invention. Such a step may occur when a third-party vendor is contracted to deliver an item sold on a site. The registration may result from negotiations with the vendor regarding what items the vendor will deliver, how many they can deliver, and the price they will charge at various volume levels. At box 504, the process makes the item available for purchase and posts an initial price. At box 506, the process receives requests for purchase, and as a result, binds requesters to terms of service. Those terms of service may allow the process to charge the buyer's credit cards when the sale is over, though perhaps limiting the charge to an amount at or below the currently displayed price for the item. At box 508, the process updates the price or discount on a web page. Thus earlier purchasers can see how much more they are saving, and new visitors can see a price that might be better for them.

At box 510, the process, determines that time has expired. This causes a wrap-up process to begin. For example, all purchasers may be provided an email that confirms their purchase and tells them the price they were ultimately charged for the item. At box 510, the process determines the final price, which may occur before notifying the buyers, and may be determined as discussed above, as a function of the number of buyers for the item. At box 512, the process charges credit cards of purchasers for the final price, and makes the item available to purchasers. The same system that runs the marketplace may fulfill the orders, and thus may simply cause a standard shipping process to occur. Alternatively, a third party may ship the goods and may be provided with data for generating shipping labels and the like, or the customer may receive a coupon or “voucher” to redeem for the vendor's goods or services. Also, the process may pay the third party for such services, at an agree-upon rate that may have occurred during operation of box 502.

More particularly, and with reference to FIG. 3, the various steps are shown in the operation of the present system. As discussed above, and with further reference to FIG. 5, a vendor registers with the operators of the present system and an initial price is determined. At this point, and as shown in FIG. 3, Jasmere posts the product for purchase at an opening price $x. Thereafter, a large number of customers view the product on the website at the posted opening price of $x.

Finally, a first customer commits to buy the product. The customer sends an electronic signal of their intention to buy to the Jasmere/market server 302, in particular, the sales module 314. The market server 302 then checks the credit card information of the customer. If the credit card information is acceptable and the sale is approved by the credit card facilitator, the sale is confirmed and a hold is applied on the customer's credit card for the purchase at $x. The market server 302, in particular, the price module 316, notes that “n” units of the products have been sold and the price module 316 compares “n” units to a prestablished pricing step function to determine whether a price reduction is warranted based upon the total number of units sold. If a pricing step is achieved, and a reduction in price warranted, the price is reducted to $x−1 (for example). If a pricing step has not been achieved by the commitment of the first customer to purchase, the price remains at $x.

Thereafter, an additional customer commits to purchase the product. The customer sends an electronic signal of their intention to buy to the market server 302, in particular, the sales module 314. The market server 302 then checks the credit card information of the customer. If the credit card information is acceptable and the sale is approved by the credit card facilitator, the sale is confirmed and a hold is applied on the customer's credit cards for the purchase at $x. The market server 302, in particular, the price module 316, notes that “n+1” units of the products have now been sold and the price module compares “n+1” units to prestablished pricing step function. If a pricing step is achieved, the price is reduced to $x−2 (for example) or $x−1, depending upon whether a price step was achieved based upon the prior purchase. If a step has not been achieved by the commitment of the first two customers to purchase, the price remains at $x or $x−1, depending upon whether a price step was achieved based upon the prior purchase.

In addition, further customers agree to buy products. The customer again sends an electronic signal of their intention to buy to the market server 302, in particular, the sales module 314. The market server 302 then checks the credit card information of the customer. If the credit card information is acceptable and the sale approved by the credit card facilitator, the sale is confirmed and a hold is applied on the customer's credit card for the purchase at $x. The market server, in particular, the price module 316, notes that “n+2” units of the products have been sold and the price module compares “n+2” units to prestablished pricing step function. If a pricing step is achieved, the price is reducted to $x−3 (for example) or $x−2 or $x−1, depending upon whether a price step was achieved based upon the prior purchase. If a step has not been achieved by the commitment of the first three customers to purchase, the price remains at $x−2 or $x−1 or $x, or $x−1, depending upon whether a price step was achieved based upon the prior purchase.

After a certain period of time, the sale time frame ends and the product is no longer available for purchase. See step 510 in FIG. 5. At this point, the operators of the present system charge the various customers, via their credit cards, the lowest daily posted price for the products sold. The credit card holds are released and the customers are told of the final payment term. Finally, the products are shipped or otherwise transferred to the customers.

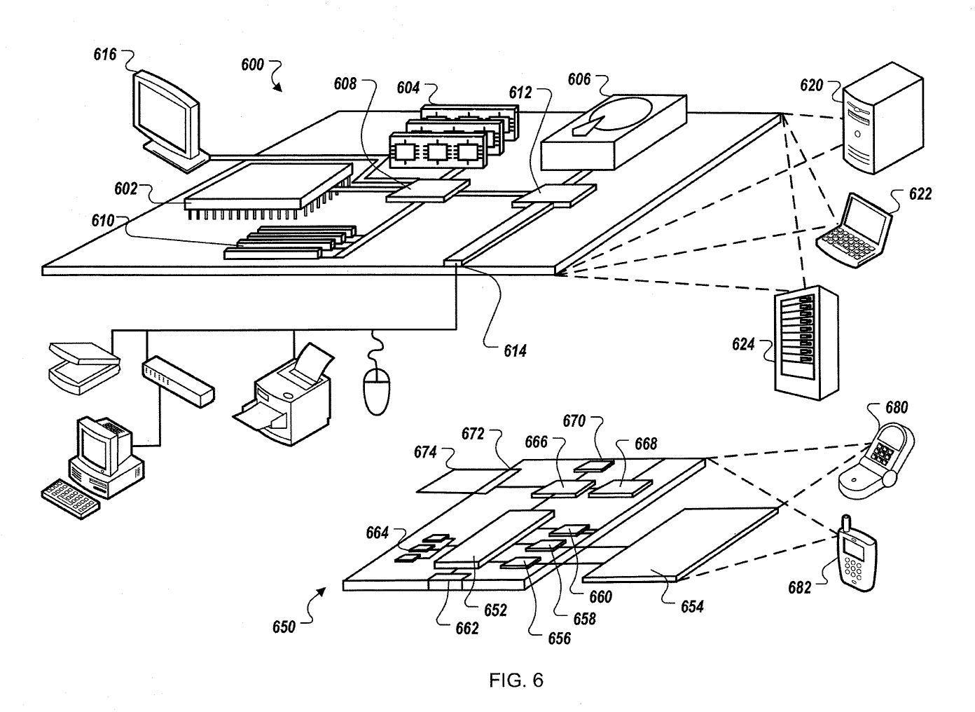

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, tablets and other similar computing devices. Additionally computing device 600 or 650 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652 that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed:

1. A computer-implemented method for making goods or services available to buyers, the method comprising:
making available for purchase, by a computer server system at an on-line service and to a plurality of potential buyers, one or more goods or services in an on-line electronic marketplace, including by pricing the goods or services at an initial price;
receiving requests to purchase the one or more goods or services from a plurality of actual buyers from among the plurality of potential buyers;
determining at the end of a predetermined time period an actual price for the goods or service based on a number of actual buyers who request to purchase the one or more goods or services, and
automatically billing the plurality of actual buyers for the one or more goods or services at the determined actual price and causing the one or more goods or services to be made available to the plurality of actual buyers.

2. The computer-implemented method of claim 1, further comprising posting or announcing an initial price for the one or more goods or services to the plurality of potential buyers before receiving requests to purchase from the plurality of potential buyers, the initial price serving as a maximum price any buyer will pay for the one or more goods or services.

3. The computer-implemented method of claim 2, further comprising periodically updating and posting a real-time price for the one or more goods or services to be shown to the plurality of potential buyers after initially making the one or more goods or services available for purchase, the real-time price falling from the initial price as a function of the number of actual buyers.

4. The computer-implemented method of claim 3, wherein the real-time price falls in pricing steps that correspond to numbers of actual buyers in groups of a predetermined size.

5. The computer-implemented method of claim 4, wherein group sizes and corresponding price changes are determined before making the one or more goods or services available for purchase.

6. The computer-implemented method of claim 2, further comprising periodically updating a real-time discount for the one or more goods or services to be shown to the plurality of potential buyers after initially making the one or more goods or services available for purchase, the real-time discount increasing from an initial discount as a function of the number of actual buyers.

7. The computer-implemented method of claim 1, further comprising providing the plurality of potential buyers with an agreement that indicates that actual buyers are bound to purchase the one or more goods or services at a price that will not exceed the initial price.

8. The computer-implemented method of claim 1, further comprising providing to potential or actual buyers a user-selectable control whose selection enables the potential or actual buyers to notify social contacts about the one or more goods or services so as to spread notice of the one or more goods or services being for sale.

9. The computer-implemented method of claim 1, further comprising receiving from a particular first user a referral that identifies a particular second user, and providing the particular first user with a credit in response to receiving the referral.

10. The computer-implemented method of claim 9, wherein the credit is not providing until the particular second user has been determined to have made a purchase with the on-line service.

11. The computer-implemented method of claim 1, further comprising maintaining a roster of registered users, the registered users having provided identification information so that different visits by a particular registered user can be correlated with each other, and requiring registration by a particular user before the particular user can become an actual buyer.

12. The computer-implemented method of claim 1, further comprising providing code to computing devices of the potential buyers showing a time remaining until a sale will close so as to trigger the determination of the actual price.

13. The computer-implemented method of claim 1, further comprising providing to the plurality of potential buyers an indication of a minimum price or maximum discount that can be achieved for the one or more goods or services.

14. The computer-implemented method of claim 13, wherein the minimum price or maximum discount has been previously negotiated with a provider of the one or more goods or services.

15. The computer-implemented method of claim 1, further comprising placing a credit card hold on a particular buyer when the particular buyer submits a request to purchase, and executing a charge to the particular buyer's credit card for the actual price after the actual price has been determined.

16. The computer-implemented method of claim 15, wherein the credit card hold is for an amount that corresponds to the initial price.

17. A computer-implemented system for making goods or service available to buyers, the system comprising:
a web interface arranged to serve code for display on computing devices for a plurality of potential buyers of one or more goods or services;
a dynamic web page generator programmed to generate the code so as to display the one or more goods or services and pricing for the one or more goods or services;
a sales module programmed to receive orders for the one or more goods or services from a plurality of actual buyers and to register the actual buyers as being buyers of the one or more goods or services upon expiration of a current sales period; and
a price determinator arranged to set a price for the one or more goods or services as a function a number of actual buyers.
